(19) United States
(12) Patent Application Publication
(10) Pub. No.: US 2016/0376195 A1
(43) Pub. Date: Dec. 29, 2016

(54) METHOD AND FACILITY FOR TREATING SLUDGE, IN PARTICULAR HARBOUR SLUDGE

(71) Applicant: Philippe VIEVILLE, GUERANDE (FR)

(72) Inventor: Philippe VIEVILLE, GUERANDE (FR)

(21) Appl. No.: 14/902,531

(22) PCT Filed: Jun. 30, 2014
(86) PCT No.: PCT/FR2014/051673

§ 371 Date: Dec. 31, 2015

(30) Foreign Application Priority Data
Jul. 3, 2013 (FR) 1356515

(51) Int. Cl. C04B 26/00; C04B 22/06; C02F 11/00; B09C 1/00; B07B 1/58; B07B 13/16; B02C 23/10; C04B 18/02; B09B 3/00

(52) U.S. Cl. CPC C04B 26/006; C04B 18/021; C04B 22/064; C02F 11/008; B09B 3/0041; B09B 3/0083; B07B 1/58; B07B 13/16; B02C 23/10; B09C 1/00; C02F 2303/24; C02F 2303/26; B07B 2201/04

(57) ABSTRACT

A method for treating sludge, in particular polluted harbour sludge, includes the following operations:—mixing the sludge with concrete and/or stone gravel,—treating the sludge/gravel mixture by crushing in order to obtain crushed material, and—carrying out a screening operation on the crushed material, simultaneously to heat treatment, in order to obtain crushed material of at least two different particle sizes. The facility for treating gravel, in particular gravel mixed with sludge, capable of implementing the method, includes crushing elements (2), screening elements (4) associated with heating elements (5), and elements (3) for transferring between the two.

### TECHNICAL FIELD TO WHICH RELATES THE INVENTION

The present invention relates to a method for treating sludge, in particular polluted harbour sludge; it also relates to a treatment facility adapted to implement this method.

### TECHNOLOGICAL BACK-GROUND

The bottom of many water areas includes sludgy masses whose thickness increases over time and which may prove very hampering, in particular in harbour areas (maritime or fluvial), due to the fact that they limit the possibilities of displacement or access of boats or ships and more generally of any nautical vehicle. Moreover, this sludge is particularly unaesthetic when it emerges from water.

Furthermore, it often includes not only sediments, sand, earth and possibly shells, but also detritus, wastes and pollutants of any nature (in particular hydrocarbons or heavy metals), this heterogeneous mixture being source of foul odours and possibly of danger.

To remedy this problem, it is conventional to regularly remove theses sludgy masses by dredging with adapted machines, such as a diggers, loaders, articulated dumpers or vacuum excavator.

But this dredged sludge does not find any particular use, and is today difficult to recycle. Therefore, it is generally stored in chosen areas to limit the trouble it is liable to cause, or the pollution it may generate.

On the other hand, it is known from the document EP-2 050 517 a method for treating contaminated water sediment material or mineral soil, consisting, after centrifuging, in reducing them into powder and mixing this powder with clay, urea, a hydraulic binder and aggregates. But such a method is relatively complex to implement, and it does not allow to obtain an easily upgradable product.

In parallel, there exist sometimes important masses of concrete and/or stone rubble, coming for example from the destruction of various constructions, such as buildings or other, that it is possible to use and to upgrade by crushing treatments by means of adapted machines such as percussion mills for example, and/or by screening/sieving treatments, by means of machines of the “scalper/screen” type, aiming to sort the rubble obtained according to particle size ranges.

The crushed/sorted rubble obtained may be used in the building and public work industry or construction industry in general, to serve as base material, load material, or as bedding material, in particular for ducts.

### OBJECT OF THE INVENTION

The present invention proposes a method for treating the sludge, after its extraction, in particular the harbour sludge, aiming to reduce its polluting character and to convert it into a form that is liable to facilitate its upgrading.

For that purpose, the method according to the invention comprises the operations consisting in:
mixing said extracted sludge with rubble containing in particular concrete and/or stone rubble,
crushing this mixture of sludge and rubble to obtain a crushed material,
performing a screening of this crushed material, simultaneously with a heating treatment, to obtain at least two different particle sizes of crushed material.

It is hence obtained granulates consisted of rubble cores partially or totally coated with dry sludge, that can then be stored or used for example as embankment material, load material or as bedding material.

Preferably, the crushing treatment of the sludge/rubble mixture is adapted to obtain a crushed material of which at least 95% in weight of the granulates obtained have a size comprised between 0 and 150 mm, still preferably comprised between 0 and 100 mm, and still preferably comprised between 0 and 80 mm. It may also be obtained smaller granulates, of which for example 95% in weight have a size comprised between 0 and 60 mm, or still preferably between 0 and 2 mm.

According to another feature, the heating treatment of the crushed material, associated with the screening operation, is preferably performed at a temperature of at least 30° C.

According to another preferential characteristic, the screening treatment is adapted to obtain at least three different particle sizes of crushed material, by at least two screening operations, each of said screening operations being associated with a heating treatment of said crushed material.

According to still another feature, the crushing treatment and/or the screening treatment of the crushed material is associated with an operation of suction of the gaseous emanations, and of treatment of these emanations by filtration, before their release into the atmosphere.

Still according to the invention, a complementary functional product is added, before the crushing operation, between this crushing operation and the screening operation, or after the screening operation, for example cement or lime, to fix and neutralise certain constituents.

The invention also relates to the facility for the treatment of rubble, in particular rubble mixed with sludge, adapted to implement the method described hereinabove, this facility including:
crushing means, adapted to crush concrete and/or stone rubble,
screening means adapted to obtain at least two different particle sizes of crushed materials, said screening means being associated with heating means, and
crushed material transfer means, between said crushing means and said screening means.

The crushing means are advantageously in the form of a percussion mill whose rotor is equipped with hammers.

As for them, the screening means are advantageously in the form of a device of the scalper type equipped with at least one screening grid provided with heating means.

The screening grid(s) of the screening means are preferably each provided with heating means arranged under their lower face.

Advantageously, these screening means include at least two superimposed screening grids, each provided with heating means arranged under their lower face.

According to another particularly interesting characteristic, the crushing means and/or screening means include a heat engine producing exhaust gases, and the heating means of said screening means are in the form of duct (s) supplied with said exhaust gases.

According to still another characteristic, at least the crushing means and/or the screening means of the facility are equipped with sheeting and/or cowling system adapted to partition off the possible gaseous emanations, which sheeting and/or cowling system is equipped with means for the suction and filtration of said gaseous emanations.

This sheeting and/or cowling system of the screening means advantageously includes vertical or substantially vertical partitioning walls, formed above the upper screening grid, which walls are arranged so as to form gas holding cells, these cells leading, in the upper part, to said above-mentioned suction and filtration means.

According to still another characteristic, the facility includes means for incorporating to the sludge/rubble mixture, or to the granulates in course of formation or finalised, a complementary functional product, for example cement or lime, to fix and neutralise certain constituents.

These means may be in the form of a dosing hopper, or a dosing conveyor, provided before the crushing means, or above the transfer means, between the crushing means and the screening means.

They may also be in the form of a mixer equipped with a dosing device, positioned at the exit of the screening means.

### DETAILED DESCRIPTION OF AN EXEMPLARY EMBODIMENT

The invention will be further illustrated, without being limited in any way, by the following description of a particular embodiment, given only by way of example and shown in the appended drawings in which:

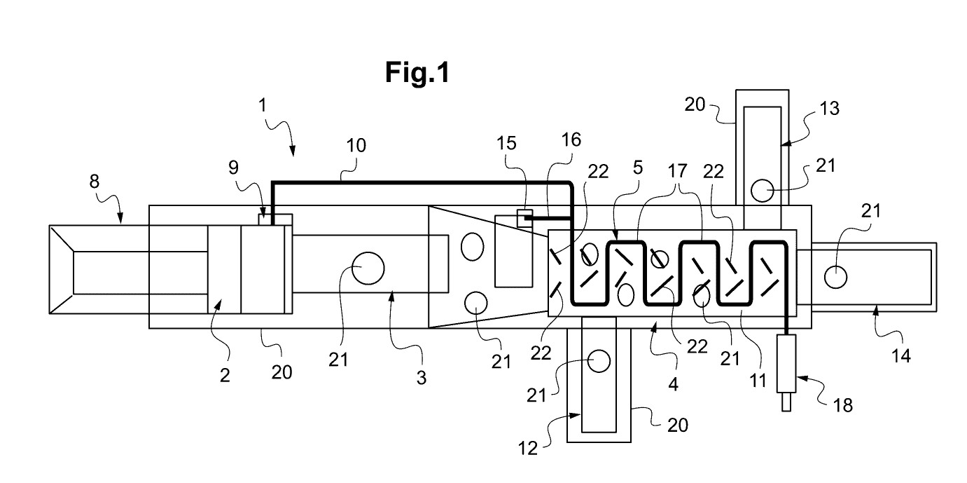

FIG. 1 is a schematic top view of a treatment facility according to the present invention;

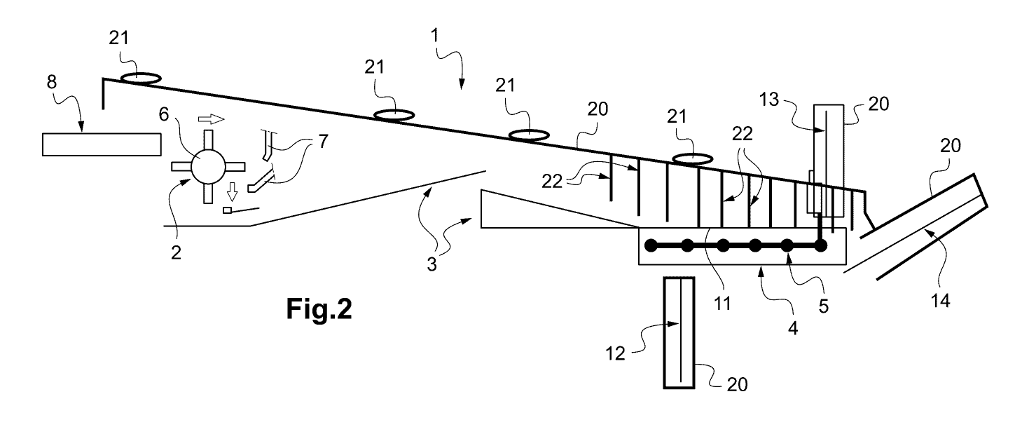

FIG. 2 is a schematic side view of the treatment facility illustrated in FIG. 1.

As illustrated in FIGS. 1 and 2, the facility 1 comprises crushing means 2 adapted to crush rubble of any nature, such as concrete, rock, stone, bitumen, ungraded material . . . , followed with means 3 allowing to transfer the crushed materials obtained towards screening means 4, adapted to obtain at least two different particle sizes of crushed materials, these screening means 4 being associated with heating means 5.

The crushing means 2 consist in a machine of the mill type, adapted to reduce the big rocks, stones or concrete blocks, into rubble of smaller size. Herein, these crushing means 2 consist in a machine known under the name of percussion crusher, or percussion mill, provided with a hammer rotor 6, associated with one or several impact screens 7, for example two in number.

Such percussion mills are commonly used in particular in mines and quarries. They are adapted to crush materials whose particle size may go up to several hundreds of millimeters, for example up to 800 mm, and after treatment, to obtain crushed materials whose particle size extends from 0 to several tens of millimeters, for example 80 mm.

The crushing means 2 include a powered supply conveyor 8, vibrating or not, to ensure the supply of the rotor 6 with products to be treated, and a powered exit conveyor 3, for the discharge of the crushed materials obtained, herein corresponding to the means of transfer to the screening means 4.

The crushing means 2 also include a heat engine 9 for driving its different mobile parts (in particular the rotor 6 and the two powered conveyors 3 and 8), this heat engine 9 including an exhaust pipe 10 for channelling the exhaust gas thereof.

The screening means 4 arranged after the percussion mill 2 are supplied by the powered transfer conveyor 3.

These screening means 4 consist in a machine adapted to screen and sort the materials, in order to obtain at least two different particle size ranges.

They more particularly consist in a machine of the scalper type, provided with at least one vibrating screening grid (schematized at 11 in FIGS. 1 and 2).

Herein, and preferentially, the screening means 4 include two superimposed screening grids, to obtain three different particle size ranges, the sorted crushed materials of each of these particle size ranges being discharged by their own powered conveyor 12, 13, 14.

By way of indication only, the screening means 4 can allow to sort the materials according to the three following particle size ranges: 0/6 mm-6/30 mm and 30/80 mm.

Here again, the screening means 4 include a heat engine 15 for the implementation in particular of the vibrating grids 11 and the discharge conveyors 12, 13, 14. This heat engine 15 includes an evacuation pipe 16 to channelize its exhaust gas.

According to a characteristic of the present invention, the screening means 4 are herein associated with heating means 5 to heat the materials in course of screening.

These heating means 5 are formed at least under the upper screening grid, adapted so as not to hamper the passage of the materials by gravity, and preferably under the two vibrating grids.

They herein consist in one or several ducts 17, suitably arranged and distributed under the lower face of each screening grid, so as to optimize the heating about the surface occupied by each of the grids 11 (without however hampering or disturbing too much the passage by gravity of the materials on the underlying grid, or on their recovering means in the form of a powered conveyor, under the lower grid).

The heating duct(s) 17 are herein connected to the pipes 10 and 16 for the evacuation of the exhaust gases of the heat engines 9 and 15, to use these exhaust gases as a heating medium. The temperature of these exhaust gases is higher than the ambient temperature and may rise to a few tens up to a few hundreds of degrees.

As can be seen in FIG. 1, the heating duct(s) 17 lead to an exhaust pipe 18, for example of the catalytic type or with complementary filter(s).

On the other hand, and according to still another advantageous characteristic of the invention, the crushing means 2, the screening means 4, as well as the transfer means 3, and possibly the supply 8 and discharge 12, 13, 14 conveyors, are covered with a sheeting and/or cowling system 20, which is adapted to partition the atmosphere about the materials in course of treatment, or in transfer, and which is associated with suction and filtration means 21. Hence, the sheeting/cowling system 20 allows to partition the possible emanations of polluting gases; and the suction/filtration means 21 allow to treat these possible emanations of polluting gases, before their release into the atmosphere.

The sheeting/cowling system 20 may be made by means of flexible covers made of plastic material, and/or by means of metal sheets, suitably arranged above and aside the different parts of the facility that is desired to be equipped.

In the upper part, this sheeting/cowling system 20 is equipped with the above-mentioned suction/filtration means 21, suitably arranged to treat at best the possible emanations of polluting gases.

These suction/filtration means 21 consist in conventional system of the suction turbine, or extraction fan, type, equipped with adapted filters, for example of the coal type or other.

Several suction/filtration modules 21 are judiciously distributed over the whole sheeting/cowling system 20, so as to allow the treatment of the full or quasi-full volume of gas collected.

As can be seen in FIGS. 1 and 2, at the screening means 4, the sheeting/cowling system 20 include internal, vertical partition walls 22, which are arranged at an angle and in staggered arrangement, above the upper screening grid.

These partitioning walls 22, arranged within the sheeting/cowling system 20, are adapted to form gas holding cells, leading in upper part to the above-mentioned suction/filtration means 21.

The facility 1 may include means for separating and putting aside the metallic elements present in the rubble or the sludge, for example in the form of a magnetic conveyor, arranged above the powered conveyor 3.

On the other hand, before the crushing means 2, between the crushing means 2 and the screening means 4, or after the screening means 4, it may be provided the presence of means for incorporating to the crushed material a functional product, in liquid or powder form, for example to fix and neutralise certain pollutants. It may for example be provided to incorporate cement or lime, for example at the rate of 0.2 to 5% of the sludge weight, to neutralise in particular the heavy metals.

For example, the facility may include for that purpose a dosing hopper or a dosing conveyor, above the supply conveyor 8 or above the transfer conveyor 3 (between the crushing means 2 and the screening means 4).

It is also possible to provide a complementary facility, of the mixer type, equipped with a dosing device, after the screening means 4, at the exit of the conveyors 12, 13, 14.

This facility 1 is particularly adapted to treat the sludge, in particular of harbour origin, as described hereinafter.

Firstly, this sludge in liquid or semi-liquid form are mixed with rubble containing in particular concrete and/or stones rubble, and/or ungraded material with possibly muddy materials, and that after a first sorting to eliminate the possible detritus and bulky wastes.

It may be previously performed a coarse premixing, by spilling the sludge on the rubble earthwork so that the sludge begins to impregnate the rubble.

For example, this premixing is made at the rate of one volume of sludge for 0.5 to 3 volumes of rubble; the corresponding ratio is determined at the time of implementation of the method, following the structural and physicochemical characteristics of the sludge to be treated.

Thereafter, this premixing is spilled on the powered conveyor 8 to supply the percussion mill 2 intended to ensure the desired operation of crushing of the materials.

More particularly, the percussion mill 2 reduces the size of the added rubble and makes/completes the mixture between this rubble and the sludge, the latter fixing on the rubble or fully coating the latter. This crushing operation partially dries the sludge.

The quantities of mixed sludge and rubble, as well as the crushing characteristics applied, in terms of size reduction, are adapted to obtain, in major part, particles or granulates formed of a rubble core at least partially coated with sludge.

The corresponding rubble/sludge crushed material is handled by the transfer means 3 to undergo a screening operation by the screening means 4, so as to perform the desired sorting operation, within which it will undergo simultaneously a heating operation ensuring the drying and the fixation of the sludge on the rubble cores.

The heating in question is performed at a temperature higher than 20° C., and still preferably higher than 30° C., on the vibrating grids 11.

It is completed, if need be, by the passage of the materials near or on the heating ducts 17, during their transfer by gravity on the underlying vibrating grid, or on the discharge means located in the lower part.

Simultaneously with the drying, the sorting of the granulates of crushed material allows to obtain different particle size ranges, each of these ranges being collected and discharged by one of the powered conveyor 12, 13, 14.

The three corresponding particle size ranges may be 0/6 mm, 6/30 mm and 30/80 mm.

Moreover, simultaneously with their crushing and screening treatment, and their transfer at least on certain of the powered conveyors 3, 8, 12, 13 and 14, the gaseous emanations coming from the sludge are trapped by the sheeting/cowling system 20, sucked up and filtered by the above-mentioned means 21, before their release into the atmosphere.

The crushing treatment favours the coating of the crushed rubble materials by the sludge, and also favours the formation of gaseous emanations filled with pollutants, for their treatment by the filtering means 21.

The screening operation, associated with the heating treatment, also favours the formation of these gaseous emanations then treated by the filtering means 21.

It is finally obtained particles or granulates formed, for the major part of them, of a hard core of rubble partially or fully coated with a dry layer of sludge, wherein these particles can be very small (of the order of one millimeter, or even less), of mean size (a few millimeters), or of greater size (a few centimeters). These particles are devoid or practically devoid of odour and they are liable to be upgraded, for example as embankment material, load material or as bedding material in particular for ducts.

As a function of the result obtained, it may be contemplated, if the treatment applied is not considered as being sufficient, to reproduce the cycle, in particular to obtain more particles of small size.

A first passage/cycle allows to control the result obtained, and possibly, to determine the interest to add a complementary functional product, before, after or between the crushing and screening means, for example cement or lime.

1-17. (canceled)

18. A method for treating sludge, in particular harbour sludge, which comprises the steps of:
mixing said sludge with rubble containing in particular concrete and/or stone rubble,
crushing this sludge/rubble mixture to obtain a crushed material, and
performing a screening of said crushed material, simultaneously with a heating treatment, to obtain at least two different particle sizes of crushed material.

19. The method according to claim 18, wherein the crushing of said sludge/rubble mixture is adapted to obtain a crushed material of which at least 95% in weight of the granulates obtained have a size comprised between 0 and 150 mm.

20. The method according to claim 19, wherein the crushing of said sludge/rubble mixture is adapted to obtain a crushed material of which at least 95% in weight of the granulates obtained have a size comprised between 0 and 100 mm, and preferably comprised between 0 and 80 mm.

21. The method according to claim 18, wherein said heating treatment of the crushed material, associated with the screening operation, is performed at a temperature of at least 30° C.

22. The method according to claim 18, wherein the crushing is adapted to obtain at least three different particle sizes of crushed material, by at least two crushing operations, each of said crushing operations being associated with a heating treatment of said crushed material.

23. The method according to claim 18, wherein the crushing and/or the screening of the crushed material is associated with an operation of suction of the gaseous emanations, and of treatment of these emanations by filtration, before their release into the atmosphere.

24. The method according to claim 18, further comprising adding to the mixture or to the crushed material, a complementary functional product, after the crushing step, between this crushing step and the screening step, or after the screening step, for example cement or lime, to fix and neutralize certain constituents.

25. A facility for the treatment of rubble, in particular the treatment of rubble mixed with sludge, which includes:
crushing means (2), adapted to crush concrete and/or stone rubble,
screening means (4) adapted to obtain at least two different particle sizes of crushed materials, said screening means (4) being associated with heating means (5), and
crushed material transfer means (3), between said crushing means (2) and said screening means (4).

26. The facility according to claim 25, wherein said crushing means (2) are in the form of a percussion mill whose rotor (6) is equipped with hammers.

27. The facility according to claim 25, wherein said screening means (4) are in the form of a scalper device equipped with at least one screening grid (11) provided with heating means (5).

28. The facility according to claim 27, wherein the screening grid(s) are each provided with heating means (5) arranged under their lower face.

29. The facility according to claim 28, wherein said screening means (4) include at least two superimposed screening grids (11), each provided with heating means (5) arranged under their lower face.

30. The facility according to claim 27, wherein said crushing means (2) and/or screening means (4) include a heat engine (9, 15) producing exhaust gases, and said heating means (5) of said screening means (4) are in the form of duct(s) (17) supplied with said exhaust gases.

31. The facility according to claim 25, wherein said crushing means (2) and/or screening means (4) are equipped with sheeting and/or cowling system (20) adapted to partition off the possible gaseous emanations, which sheeting and/or cowling system (2) is equipped with means (21) for the suction and filtration of said gaseous emanations.

32. The facility according to claim 31, wherein the sheeting and/or cowling system (20) of the screening means (4) includes vertical or substantially vertical partitioning walls (22), formed above the upper screening grid (11), which walls (22) are arranged so as to form gas holding cells, these cells leading, in the upper part, to said suction and filtration means (21).

33. The facility according to claim 25, further including means for incorporating to the sludge/rubble mixture, or to the granulates in course of formation or finalized, a complementary functional product, said means, of the dosing hopper or dosing conveyor type, being provided before said crushing means (2), or between said crushing means (2) and said screening means (4).

34. The facility according to claim 25, further including means of the mixer type equipped with a dosing device, positioned downstream from said screening means (4), to allow the incorporation to the granulates of a complementary functional product.
